(19) United States
(12) Patent Application Publication
(10) Pub. No.: US 2013/0342147 A1
(43) Pub. Date: Dec. 26, 2013

(54) ASSEMBLY FOR CONTROLLING AN ELECTRIC VACUUM PUMP

(71) Applicants: Dieter Bidlingmeyer, Langquaid (DE); Alexander Kalbeck, Burglengenfeld (DE); Bernd Pfaffeneder, Regensburg (DE); Michael Irsigler, Regensburg (DE); Christian Märkl, Wald (DE)

(72) Inventors: Dieter Bidlingmeyer, Langquaid (DE); Alexander Kalbeck, Burglengenfeld (DE); Bernd Pfaffeneder, Regensburg (DE); Michael Irsigler, Regensburg (DE); Christian Märkl, Wald (DE)

(73) Assignee: CONTINENTAL AUTOMOTIVE GMBH, Hannover (DE)

(21) Appl. No.: 13/982,591

(22) PCT Filed: Jan. 24, 2012
(86) PCT No.: PCT/EP12/51011

§ 371 Date: Sep. 11, 2013

(30) Foreign Application Priority Data
Jan. 31, 2011 (DE) 10 2011 003 360.2
Dec. 19, 2011 (DE) 10 2011 088 976.0

(51) Int. Cl. H02P 1/20

(52) U.S. Cl. CPC H02P 1/20
USPC 318/430

(57) ABSTRACT

An assembly for controlling an electric vacuum pump for a vehicle, which is connectable by at least one switch, which can be controlled by an electronic control unit, to a supply voltage, wherein the electronic control unit in a start-up phase connects the vacuum pump to an additional electrical resistor between the supply voltage and the vacuum pump.

### CROSS REFERENCE TO RELATED APPLICATIONS

This application is the U.S. National Phase Application of PCT/EP2012/051011, filed Jan. 24, 2012, which claims priority to German Patent Application Nos. 10 2011 003 360.2, filed Jan. 31, 2011 and 10 2011 088 976.0, filed Dec. 19, 2011, the contents of such applications being incorporated by reference herein.

### FIELD OF THE INVENTION

The invention relates to an assembly for controlling an electric vacuum pump for a vehicle.

### BACKGROUND OF THE INVENTION

Electric vacuum pumps which, in vehicles (preferably passenger cars), replace the conventional methods for generating a negative pressure (vacuum by engine intake in the case of petrol engines or mechanical vacuum pumps in the case of diesel engines) are known from the prior art. This vacuum or negative pressure is required in the vehicles inter alia in order to assist or boost the braking power.

Pumps of this type can be controlled by means of relays or a separate control unit (ECU), which connect the pumps to the respective on-board power supply system. With a 12 V on-board power supply system, inrush currents with peaks up to 100 A may occur here in specific situations. In modern vehicle architectures, attempts are made to reduce this power peak significantly so as not to impair systems operating in parallel. It is therefore sought, in particular when starting actuators or pumps, to limit the inrush current to an acceptable value (20 A-30 A).

Known solutions for overcoming or mitigating this problem often utilize what is known as pulse-width modulation (PWM) in order to control the power electronics. Here, the power stages of the electronics system to be controlled or the relay is/are controlled with a higher frequency and a variable pulse/pause ratio. With the corresponding electronics system connected, the voltage and therefore the current used by the motor is thus limited. Due to the pulsing, considerably worsened EMC (electromagnetic compatibility) behavior is to be anticipated however with currents of this magnitude and generally significantly exceeds the limits valid in the automotive field. This disadvantage can only be overcome, if at all, by means of very complex and costly additional circuits.

### SUMMARY OF THE INVENTION

An aspect of the invention is an assembly of the type mentioned in the introduction which, with the simplest possible structure, reduces the starting current occurring in the start-up phase compared to the conventional solution and which induces as few voltage and/or current pulses as possible into the supply network.

The inrush current is limited in that, for the duration of the start-up of the pump (in the order of 100-200 ms), at least one additional resistor is connected between the supply voltage and the motor of the electric vacuum pump. The current is thus additionally limited statically resistively. Once a start-up phase has elapsed (as soon as the pump runs within normal parameters), the switchover to a quasi resistance-free path is implemented, such that the full power of the pump is available.

The duration of the starting current is dependent on the respective system and can be predefined. By contrast with PWM, the resistive load integrated in the electric circuit does not cause any lasting negative EMC disturbances. Only by means of the switching process can a low interference pulse occur due to the connection of the resistance loads, since in this case there is always a noticeable difference between the resistance values of the two switching stages and therefore of the effective current.

The use of switchable resistance paths makes it possible to limit the starting current of the pump motor. In contrast to the frequently used PWM method, the described technique additionally solves the problem of EMC disturbances during the start-up limitation.

In accordance with an embodiment of the invention, peak pulses possibly occurring during the switching process between resistive load and load-free mode can be reduced by means of an embodiment with a plurality of parallel paths and resistive loads connectable sequentially. These additionally have the advantage that the dimensioning (power) of the individual components can be reduced, thus constituting a more cost-effective solution where necessary.

These resistance paths with their additional resistors can also be connected in parallel in groups, wherein, by suitable selection of each of the connected resistors at different moments in time, an increasingly reduced total resistance can be connected. Good gradation of the connected resistance values can thus be achieved with relatively few additional resistance paths.

Further, in accordance with another embodiment of the invention, a reduction of the power of the additional components can be achieved by arranging the resistance path or the resistance paths in the low-side path of the pump between the minus pole of the supply voltage and the vacuum pump motor.

Since the effective current and therefore in particular the inrush (starting) current are dependent on different parameters (for example on-board voltage, circuit and/or pump temperature), in accordance with a further embodiment of the invention, the connection time of the additional resistance paths can be selected in a manner dependent on the respective parameters. This should occur in such a way that, with an increase or anticipated extension of the inrush loads of the current, the resistance path remains activated for longer. In other words, the activation time rises linearly with the on-board voltage, for example. Since, at lower temperatures, the ohmic resistance of the pump motor also decreases, the start-up phase and therefore the turn-on time of the resistance path(s) is therefore to be extended.

In both cases, the linear dependence can also be replaced by a characteristic map stored in the control device.

In accordance with a further embodiment of the invention, the current uptake of the motor can also be measured by means of the voltage dropping across the resistance branch. The measurement of current can be used to determine the disconnection of the resistance branch. Here, the resistance branch is disconnected at the moment at which the effective current has fallen below a maximum limit (for example 30 A). The value should again be configurable in this case, and where appropriate debounced via a definable delay in order to rule out fluctuation effects.

Disconnection of the resistance branch or path in each case means the disconnection of the resistance path with simultaneous connection of the normal circuit path, which is substantially resistance-free (a quasi short circuit to GND).

In accordance with a further embodiment of the invention, the current uptake of the motor can be established cyclically, even if the resistance path is already bridged by the low-side switch and is therefore no longer active, by briefly deactivating the low-side switch and simultaneously remeasuring the voltage at the resistance branch.

In accordance with a further embodiment of the invention, the indication of a running pump motor can also be used for the switchover of the resistance path(s). Here, the resistance path remains activated until a correct start-up of the pump is identified (for example via the pump speed). A limit value for the nominal speed can be configurable here.

So as not to prevent a start-up of the pump by the additional resistive load under certain ambient conditions (for example undervoltage, low temperature), in accordance with a further embodiment of the invention, in the event of detection of a non-starting pump, optionally according to a defined time condition, the additional resistance paths can be connected sequentially where appropriate (lowering of the total resistance).

One technical challenge encountered with the above-mentioned embodiments is to reduce the heating of the semiconductor elements in the power circuit of the electronics system to such an extent that the service life of said elements is not impaired or even damaged. In accordance with a further embodiment of the invention, the temperature of the electronic board or of the semiconductor elements can also be utilized. If the temperature of the semiconductor element or the modeled temperature of the element or the temperature of the power electronics determined via the temperature of the electronic board (possibly via a model) exceeds a defined limit value, the resistance path is disconnected for protective purposes. In this case, a possible increased starting current is then accepted.

### BRIEF DESCRIPTION OF THE DRAWINGS

Some exemplary embodiments of the invention will be explained in greater detail hereinafter with reference to the drawing, in which:

FIG. 1 shows a first exemplary embodiment of the assembly according to the invention with an additional resistance path,

FIG. 2 shows further exemplary embodiments of the assembly according to the invention with two or more additional resistance paths.

### DETAILED DESCRIPTION OF THE INVENTION

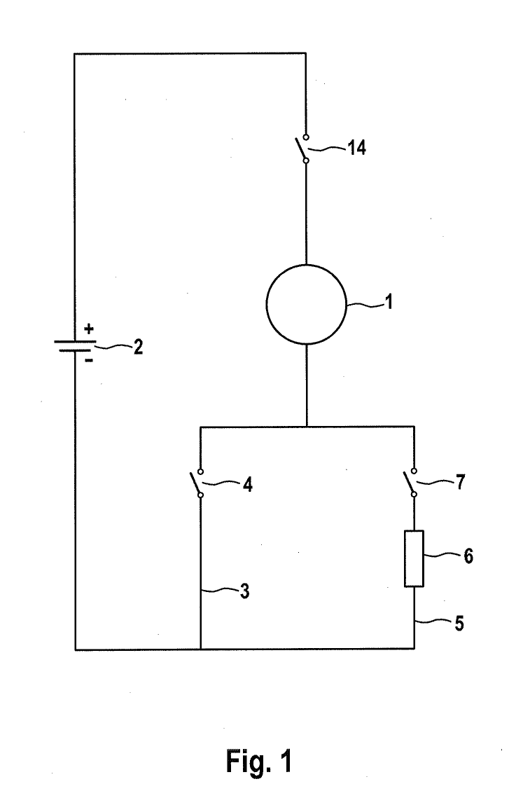

A circuit diagram of a first exemplary embodiment of the assembly according to the invention is illustrated in FIG. 1.

An electric motor 1 of a vacuum pump (not illustrated in greater detail) is indicated and can be used in a vehicle, for example in order to assist or boost the braking power.

The electric vacuum pump or the motor 1 thereof is supplied with electrical energy from a DC voltage source 2. To this end, a quasi resistance-free path 3 is provided between the minus pole of the DC voltage source 2 and the motor 1 by means of an electronic switch 4.

The electronic switch 4 is actuatable by means of an electronic control unit (not indicated in the figure), that is to say said switch can be closed or opened in a manner controlled electronically by said control unit.

If the switch 4 is closed, a closed electric circuit with voltage source 2, path 3 with switch 4, and also motor 1 is thus produced, such that the motor 1 is supplied with electrical energy in a quasi resistance-free manner by the voltage source 2 and is in operation, such that the vacuum pump generates a vacuum or negative pressure in a desired manner.

When this electric circuit is closed and therefore when the motor 1 or the vacuum pump is connected, increased currents, or what are known as starting currents, occur in the electric circuit without further measures in a start-up phase, in which the motor 1 has not yet reached its nominal speed. These currents are undesirable and load the voltage source 2 to an unusually high extent such that the voltage thereof may fall, whereby the function of other components in the vehicle, which are likewise supplied with electrical energy by the voltage source 2, can in turn be impaired.

An aspect of the invention is therefore to reduce or even avoid these starting currents.

To this end, the assembly according to an aspect of the invention according to FIG. 1 has a resistance path 5 with an ohmic resistor 6 and an electronic switch 7, which is likewise actuatable by means of the electronic control unit.

The two paths 3 and 5 are arranged in parallel and can be connected alternatively into the electric circuit by means of the switches 4 and 7. The path 3 is quasi resistance-free, whereas the resistance path 5 has the ohmic resistor 6.

A quasi resistance-free connection from the minus pole of the voltage source 2 and a terminal of the motor 1 or alternatively the same connection via the ohmic resistor 7 can thus be connected by corresponding opposed actuation of the switches 4 and 7.

In order to limit the above-explained increased starting currents resistively in the start-up phase of the motor 1, the electronic control unit opens the switch 4 and closes the switch 7 in the start-up phase. The ohmic resistor 6 is thus connected into the electric circuit and limits the starting current resistively.

Once the start-up phase has elapsed, that is to say for example after a predefinable period of time (100 to 200 ms) or once the starting current has been reduced sufficiently, the switch 4 is closed and the switch 7 is opened. The assembly is then in its normal operating mode and the motor 1 is coupled in a quasi resistance-free manner to the voltage source 2.

To summarize, the resistor 6 is thus connected into the electric circuit only in the start-up phase for the purpose of limiting the starting current resistively.

By simply switching the two switches 4 and 7, an extremely effective ohmic limitation of the starting current of the motor 1 of the vacuum pump is thus achieved, wherein the extent of this current limitation can be adjusted by appropriate selection of the size of the ohmic resistor 6.

An emergency switch 14 can be provided between the plus pole of the voltage source 2 and the second terminal of the motor 1 in order to provide the possibility of a second emergency disconnection.

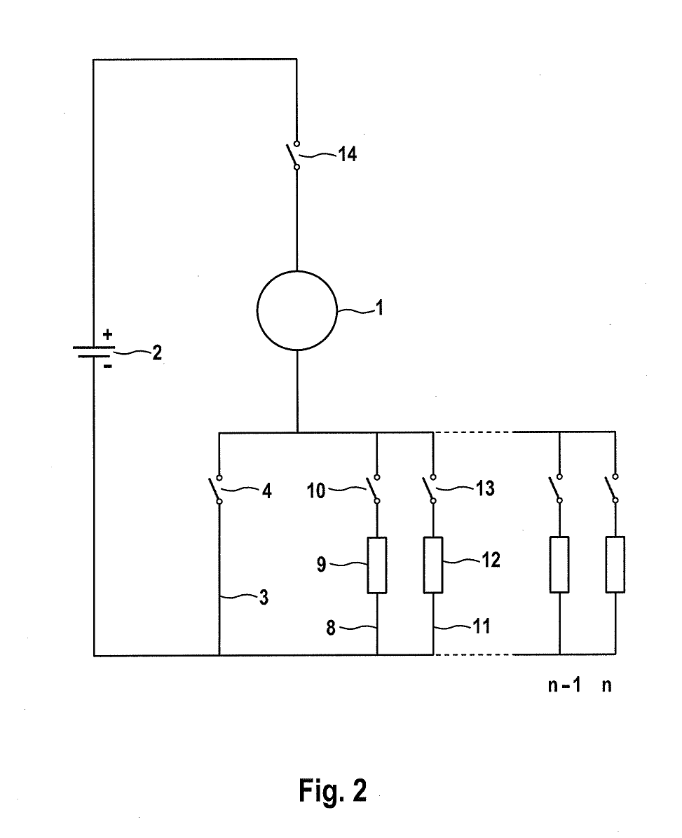

FIG. 2 likewise shows a further exemplary embodiment of the assembly according to the invention in the form of a circuit diagram.

Similarly to the exemplary embodiment according to FIG. 1, this assembly has a motor 1 of a vacuum pump, a quasi resistance-free path 3 with switch 4, and also a voltage source 2.

By contrast, two paths 8 and 11 are now provided parallel to the resistance-free path 3, wherein the path 8 has an ohmic resistor 9 and an electronic switch 10, and the path 11 has an ohmic resistor 12 and an electronic switch 13.

The ohmic values of the two resistors 9 and 12 are selected so as to be different. It will be assumed hereinafter that the resistor 12 has a higher ohmic resistance value than the resistor 9.

In order to achieve a yet further improved limitation of the starting current and even smaller current fluctuations in the electric circuit during and at the end of the start-up phase, the electronic control unit initially actively connects the higher resistor 12 at the start of a start-up phase by closing the switch 13. In this phase, the switches 10 and 4 are open.

After a predefinable period of time or once another condition has been met (still within the start-up phase), the switch 13 is then opened and the switch 10 is closed, such that the smaller resistor 9 is now connected into the electric circuit. Once the start-up phase has elapsed, the switch 10 is then opened and the switch 4 is closed.

By sequentially closing the switches 13, 10 and 4, a further improved limitation of the starting current is thus achieved, wherein reduced current pulses occur as a result of the ohmic gradations, even when switching over between the switches.

This behavior can be refined and increased further still by providing further resistance paths in addition to the paths 8 and 14, as is indicated in FIG. 2 on account of the paths n−1 and n.

These paths 8, 14, n−1 and n can be actively connected in succession in accordance with the process described above. It is also possible to actively connect not just one path simultaneously, but two or more paths at the same time, that is to say to connect these paths in parallel.

In both cases, a fine gradation of the ohmic resistance value effective on the whole and therefore a finely graduated drop thereof in the start-up phase can be achieved by a suitable selection of the resistance values over the course of the start-up phase, such that a desired resistive limitation of the starting current is achieved on the one hand, and pulses occurring when switching over between the switches are also minimized where appropriate, since the jumps in the respective active resistance values can be kept small.

### LIST OF REFERENCE SIGNS

1 vacuum pump motor
2 voltage source
3 resistance-free path
4 electronic switch in the resistance-free path
5 resistance path
6 resistor
7 electronic switch in the resistance path
8,11 resistance paths
9,12 resistors in resistance paths
10,13 electronic switches in resistance paths
14 emergency switch
n−1, n resistance paths

1.-13. (canceled)

14. An assembly for controlling an electric motor of a vacuum pump for a vehicle, wherein an electronic control unit in a start-up phase connects the motor by means of electronic switches, which can be controlled by said control unit, to a supply voltage via at least one resistance path provided with an additional resistor and, once the start-up phase has elapsed, connects said motor to said supply voltage in a substantially resistance-free manner.

15. The assembly as claimed in claim 14, wherein at least two resistance paths are provided, wherein the paths have differently or equally sized electrical resistors of different values, which are actively connected sequentially or in groups into the start-up phase by respective electric switches provided in the resistance paths.

16. The assembly as claimed in claim 15, wherein the start-up phase considered by the start-up control unit and in which an increased starting current occurs has a duration from approximately 100 to 200 ms.

17. The assembly as claimed in claim 15, wherein the electronic control unit, in the event of detection of a non-starting pump motor after a predefinable time, connects additional resistance paths in parallel.

18. The assembly as claimed in claim 14, wherein the start-up phase considered by the start-up control unit and in which an increased starting current occurs has a duration from approximately 100 to 200 ms.

19. The assembly as claimed in claim 14, wherein the at least one additional electrical resistor and the electronic switches are connected between the minus pole of the voltage source and the vacuum pump.

20. The assembly as claimed in claim 14, wherein the duration of the start-up phase is stored in the electronic control unit, which controls the electronic switches accordingly.

21. The assembly as claimed in claim 14, wherein the electronic control unit extends the start-up phase if the temperature falls below a predefinable temperature value and/or if a predefinable maximum supply voltage is exceeded.

22. The assembly as claimed in claim 14, wherein the electronic control unit measures the current uptake of the motor via the additional resistor(s) and then terminates the start-up phase when the measured current exceeds a predefinable maximum value for a definable period of time t.

23. The assembly as claimed in claim 14, wherein the electronic control unit determines the current uptake of the motor by temporarily separating the supply voltage with simultaneous activation and measurement of the voltage at the resistance path and then terminates said current uptake when the measured voltage exceeds a predefinable maximum value.

24. The assembly as claimed in claim 23, wherein the electronic control unit also carries out the voltage measurement cyclically after the start-up phase.

25. The assembly as claimed in claim 14, wherein the electronic control unit terminates the start-up phase in accordance with the speed of a motor of the vacuum pump.

26. The assembly as claimed in claim 14, wherein the electronic control unit disconnects the resistor or the additional resistors when it determines that one or more electronic components of the assembly has/have exceeded a predefinable maximum temperature.

27. A vehicle with an assembly for controlling an electric motor of a vacuum pump for a vehicle, wherein an electronic control unit in a start-up phase connects the motor by means of electronic switches, which can be controlled by said control unit, to a supply voltage via at least one resistance path provided with an additional resistor and, once the start-up phase has elapsed, connects said motor to said supply voltage in a substantially resistance-free manner.
